(19) United States
(12) Patent Application Publication
(10) Pub. No.: US 2017/0205320 A1
(43) Pub. Date: Jul. 20, 2017

(54) METHOD AND APPARATUS FOR CELL BLOCK PREPARATION OF CYTOLOGY SPECIMENS

(71) Applicant: MUSC FOUNDATION FOR RESEARCH DEVELOPMENT, Charleston, SC (US)

(72) Inventors: Kathryn LINDSEY, Wadmalaw Island, SC (US); Wanda SHOTSBERGER, Monks Corner, SC (US); Patricia M. HOUSER, Mt. Pleasant, SC (US); Jack YANG, Mt. Pleasant, SC (US)

(73) Assignee: MUSC FOUNDATION FOR RESEARCH DEVELOPMENT, Charleston, SC (US)

(21) Appl. No.: 15/320,796

(22) PCT Filed: Jul. 10, 2015
(86) PCT No.: PCT/US2015/040008

§ 371 Date: Dec. 21, 2016

Related U.S. Application Data
(60) Provisional application No. 62/024,031, filed on Jul. 14, 2014.

(51) Int. Cl. G01N 1/36; G01N 1/28; G01N 1/30

(52) U.S. Cl. CPC G01N 1/36; G01N 1/30; G01N 1/286; G01N 2001/305; G01N 2001/364

(57) ABSTRACT

Embodiments disclosed herein relate to methods and apparatus for cell block preparation of cytology specimens. Specific embodiments relate to methods and apparatus for formal-in fixed paraffin embedded cell block preparation of cytology specimens.

### CROSS-REFERENCE TO RELATED APPLICATIONS

This application claims priority to U.S. Provisional Patent Application 62/024,031, filed Jul. 14, 2014, the contents of which are herein incorporated by reference.

### BACKGROUND OF THE INVENTION

1. Field of the Invention

This invention relates to methods and apparatus for cell block preparation of cytology specimens. Specific embodiments relate to methods and apparatus for formalin fixed paraffin embedded cell block preparation of cytological specimens.

2. Description of Related Art

Cell blocks are a useful adjunct to other cytoprepartory methods and when successful, yield multiple histologic sections for subsequent special and immunohistochemical (IHC) staining to classify tumors, lesions, or normal tissues. In addition, cell blocks provide lesional cells for molecular diagnostics to determine treatment regimens. Traditional cell block preparation methods are expensive, labor intensive, and often yield less than adequate numbers of lesional cells for diagnosis or ancillary testing. Some techniques use fixatives other than formalin which can interfere with IHC. Automated methods are typically expensive, time consuming, and use alcohol (instead of formalin) as the fixative.

In addition, many laboratories use expired blood products (e.g. thrombin) to coagulate the specimen, which may introduce biologic markers. Others use an agarose gel method to agglutinate cells through histologic processing. The agarose gel and thrombin methods often render the specimen invisible in the cell block, and the lesional cells can be completely cut away at the time of sectioning. Visible markers can be used but are cumbersome to add and may interfere with IHC staining.

A need therefore exists for improved apparatus and methods of cell block preparation.

### SUMMARY OF THE INVENTION

Exemplary embodiments of the present disclosure comprise apparatus and methods for preparation of histologic sections from cytology specimens (e.g. cell blocks) for in less time and at less cost than traditional methods. In certain embodiments, the fixative used during the specimen preparation is formalin, and the cell block can be embedded with paraffin wax. In exemplary embodiments, the specimen can be processed using standard procedures, using equipment typically found in a cytology lab.

Cell blocks are a useful adjunct to other cytopreparatory methods, and when successful, yield multiple histologic sections for subsequent special and immunohistochemical (IHC) staining to classify tumors. In addition, cell blocks provide lesional cells for molecular diagnostics to determine treatment regimens. Exemplary embodiments of the disclosed apparatus produce cell blocks quickly, without difficulty, and inexpensively. The specimen processing can be readily implemented into laboratory settings. One advantage of exemplary apparatus is that cell blocks can be generated using formalin as the fixative which does not impede or alter immunohistochemical stains. Cytogenetic tests have also been successful with methods according to the present disclosure. Exemplary methods have been validated with quality control comparative studies. In one example analysis, forty-one residual cytologic specimens were used to prepare cell blocks using the disclosed methods. Forty of the forty-one (98%) cases yielded a cellular sample. The disclosed methods produced cellular samples regardless of formalin or alcohol fixation.

In contrast to embodiments of the present disclosure, traditional cell block preparation methods are expensive, labor intensive, and often yield less than adequate numbers of lesional cells for diagnosis or ancillary testing. For example, some techniques use fixatives other than formalin which can interfere with IHC. In addition, automated methods are typically expensive, time consuming, and use alcohol as the fixative. Furthermore, many laboratories use expired blood products to coagulate the specimen which may influence the outcome. Others use an agarose gel method to agglutinate cells through histologic processing. The agarose gel and thrombin methods often render the specimen invisible in the cell block, and the lesional cells can be completely cut away at the time of sectioning. Visible markers can be used but are cumbersome to add and may interfere with IHC. Applications of embodiments disclosed herein include diagnostic and molecular testing for targeted therapies in cytopathology laboratories, including for example clinical research and basic science research for aspirate or fluid specimens.

Exemplary embodiments of the present disclosure include an apparatus comprising: a foam receptacle comprising a well; and a reservoir comprising an aperture proximal to the foam receptacle, where the reservoir is coupled to the foam receptacle such that the aperture is in fluid communication with the well of the foam receptacle. In particular embodiments, the foam receptacle is an open cell absorbent polymer foam, and in specific embodiments the foam receptacle comprises a first layer and a second layer. In some embodiments, the first layer and the second layer are comprised of absorbent material. In certain embodiments, the well is formed in the first layer and wherein the well does not extend through the second layer.

In particular embodiments, the reservoir further comprises an aspirated specimen comprising suspended biological cells, and in some embodiments, the well in the foam receptacle contains a cell pellet. In specific embodiments, the foam receptacle is approximately 5 mm thick and has a maximum dimension of approximately 3 cm. In certain embodiments, the foam receptacle is a square approximately 1 cm by 1 cm and is approximately 3 mm thick. Particular embodiments further comprise a funnel in fluid communication with the reservoir. Some embodiments further comprise a support member coupling the funnel and the reservoir. Specific embodiments further comprise a retaining member configured to retain the reservoir and the foam receptacle during a centrifuging process. Certain embodiments further comprise a support member coupling the funnel and the reservoir.

In particular embodiments, the retaining member comprises a clip configured to retain the support member to the retaining member. Specific embodiments further comprise a protective wrap between the foam receptacle and the retaining member, and in some embodiments the protective wrap is tissue paper.

Exemplary embodiments of the present disclosure also include a method of preparing an embedded cell block cytology specimen, where the method comprises: placing a specimen comprising suspended cells in a reservoir; centrifuging the specimen from a reservoir to a well in a foam receptacle; processing the foam receptacle to remove aqueous components from the specimen; and embedding wax in the foam receptacle.

Certain embodiments further comprise sectioning the foam receptacle into sections, and in particular embodiments, the sections are approximately 4 microns thick. In specific embodiments, the reservoir comprises an aperture in fluid communication with the well in the foam receptacle, and in some embodiments, placing the specimen in the reservoir comprises pouring the specimen into a funnel coupled to the reservoir.

Exemplary embodiments of the present disclosure include a cell block comprising: a first layer comprising an open cell absorbent polymer foam; a second layer comprising an absorbent material; and a well formed in the open cell absorbent polymer foam, where the well does not extend through the second layer; the cell block is less than 5 mm thick; and the maximum dimension of the cell block is less than 5 cm. In particular embodiments, the maximum dimension of the cell block is less than 4 cm, or less than 3 cm, or less than 2 cm. In specific embodiments, the maximum dimension of the cell block is approximately 1 cm. Certain embodiments further comprise a cell pellet in the well formed in the open cell absorbent polymer foam. In specific embodiments, the cell block further comprises paraffin wax embedded in the open cell absorbent polymer foam.

As used in this specification, “a” or “an” may mean one or more. As used herein in the claim(s), when used in conjunction with the word “comprising,” the words “a” or “an” may mean one or more than one.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” may mean at least a second or more.

Throughout this application, the term “about”, “approximately” or related terms are used to indicate that a value includes the inherent variation of error for the device, the method being employed to determine the value, or the variation that exists among the study subjects.

Any embodiment of any of the present methods, kits, and compositions may consist of or consist essentially of—rather than comprise/include/contain/have—the described features and/or steps. Thus, in any of the claims, the term “consisting of” or “consisting essentially of” may be substituted for any of the open-ended linking verbs recited above, in order to change the scope of a given claim from what it would otherwise be using the open-ended linking verb.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIG. 1 is an exploded assembly view of a first embodiment of the present disclosure.

FIG. 2 is a schematic of the preparation of a specimen to be used with the embodiment of FIG. 1.

FIG. 3 is a schematic of the preparation of a specimen to be used with the embodiment of FIG. 1.

FIG. 4 is a perspective view of the embodiment of FIG. 1 during use.

FIG. 5 is a perspective view of the embodiment of FIG. 1 during use.

FIG. 6 is a comparison of a cell block prepared according to traditional techniques, and a cell block according to embodiments of the present disclosure.

FIG. 7 is an image of an ascitic fluid specimen prepared according to exemplary embodiments of the present disclosure exhibiting adenocarcinoma.

FIG. 8 is an image of an ascitic fluid specimen prepared according to exemplary embodiments of the present disclosure exhibiting adenocarcinoma.

FIG. 9 is an image of a breast cell specimen prepared according to exemplary embodiments of the present disclosure exhibiting cytokeratin 7 (CK7).

FIG. 10 is an image of a lymph node specimen prepared according to exemplary embodiments of the present disclosure exhibiting poorly differentiated carcinoma.

FIG. 11 is an image of a pericardial fluid specimen prepared according to exemplary embodiments of the present disclosure exhibiting adenocarcinoma.

### DETAILED DESCRIPTION OF EXEMPLARY EMBODIMENTS

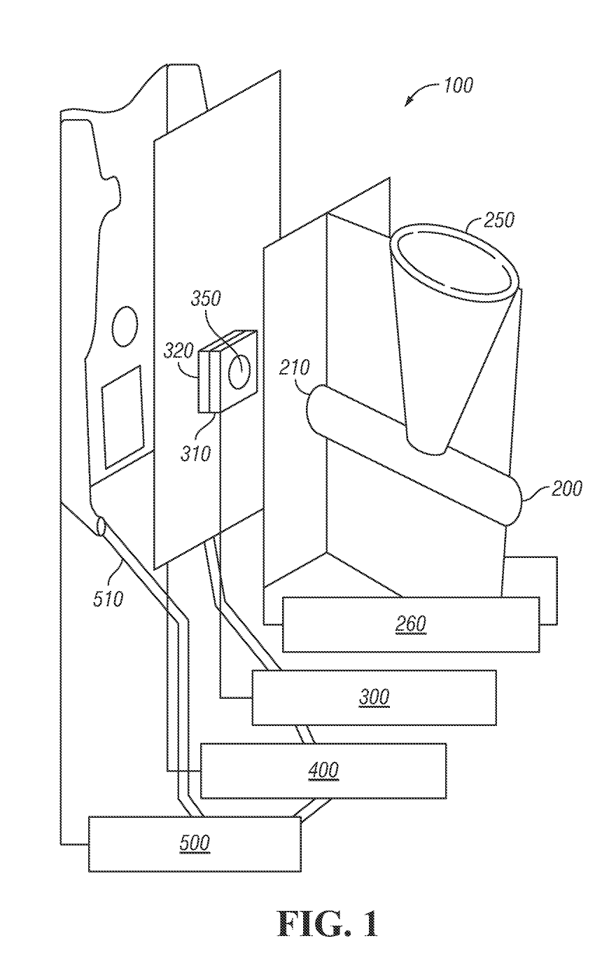

Referring now to FIG. 1, an exploded assembly view of an apparatus 100 comprises a reservoir 200, a foam receptacle 300, a protective wrap 400, and a retaining member 500 configured to retain apparatus 100 in a centrifuge (not shown). As explained further below, apparatus 100 can be used in the preparation of formalin fixed paraffin embedded cell block cytology specimens.

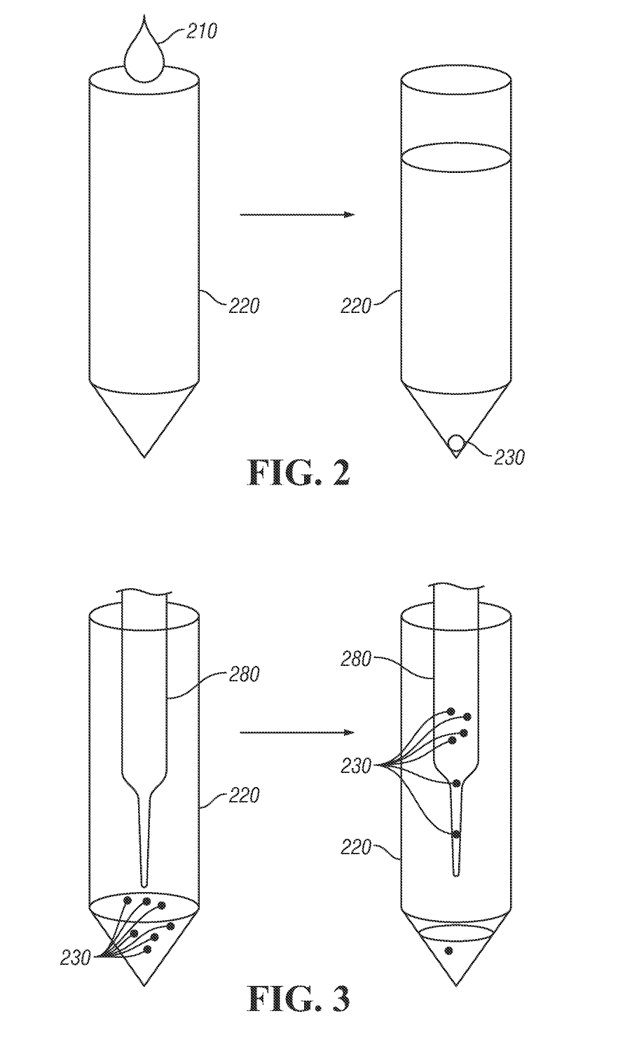

In certain embodiments, a specimen can be initially prepared prior to insertion into reservoir 200. For example, referring now to FIG. 2, a formalin fixed specimen 210 can be added to a conical vial 220 and centrifuged to produce a cell pellet 230. In a particular embodiment, vial 220 can be centrifuged for 5 minutes at 2700 rpm, while in other embodiments different times and/or rotational speeds may be used. As shown in FIG. 3, the supernatant can be poured off leaving a reduced volume (e.g. 1 mL) and cell pellet 230 may be re-suspended (e.g. by agitating conical vial 220). A portion (e.g. approximately one half or 0.5 mL) of the re-suspended cell pellet can then be aspirated, e.g. via a plastic transfer pipette 280.

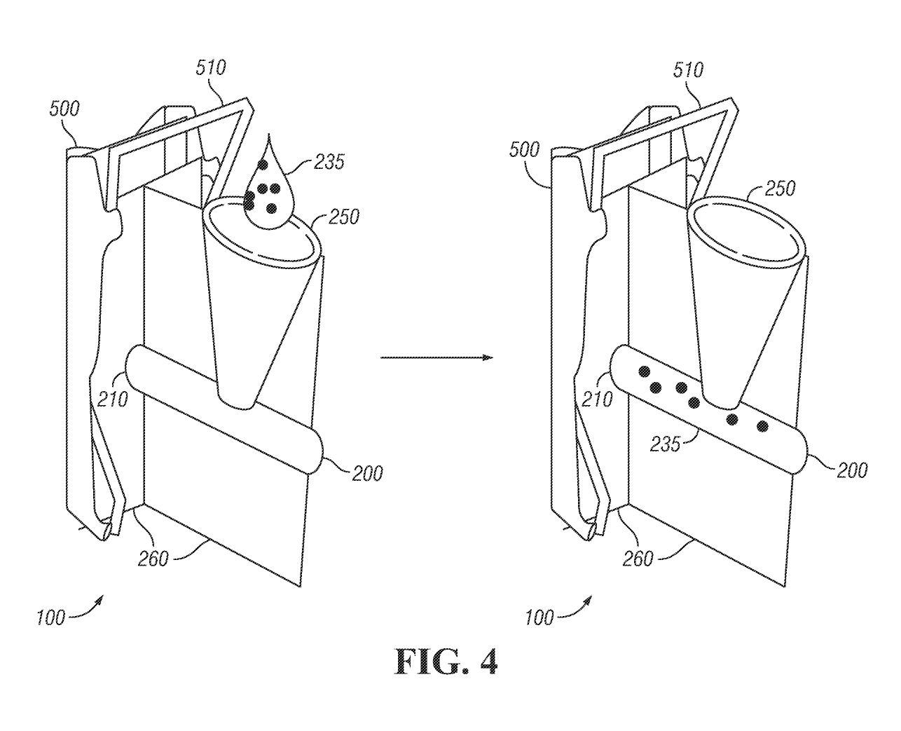

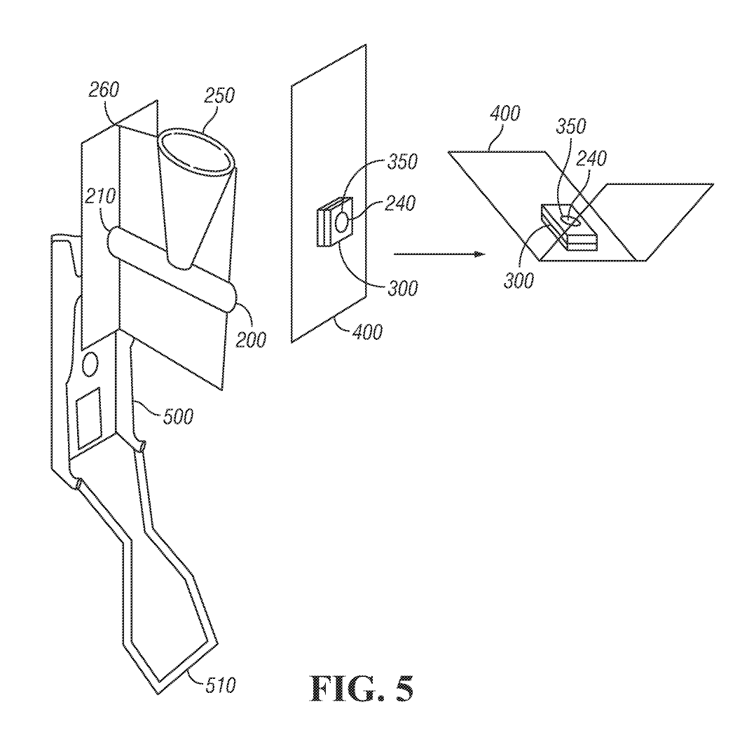

Referring now to FIG. 4, aspirated specimen 235 (comprising suspended cell pellet 230) can be added to reservoir 200 of assembled apparatus 100. In the embodiment shown, a support member 260 couples a funnel 250 to reservoir 200 to allow for the addition of aspirated specimen 235 to reservoir 200. It is understood that other embodiments may not comprise a funnel coupled to reservoir 200, and that reservoir 200 may comprise a different configuration from that shown in the figures. For example, reservoir 200 may be configured as a conical vial with an opening coupled to the foam receptacle such that the aperture is in fluid communication with the well of the foam receptacle or other configuration suitable for centrifuging. Also shown in FIG. 4, support member 260 can be secured to retaining member 500 via a clip 510.

In exemplary embodiments, the volume of aspirated specimen 235 does not exceed the capacity of reservoir 200. In a specific embodiment, apparatus 100 can be centrifuged for 5 minutes at 1,000 rpm, although other times and rotational speeds may be used in other embodiments. During the centrifuging process, aspirated specimen 235 exits reservoir 200 via an aperture 210 that is proximal to foam receptacle 300. Aspirated specimen 235 can then collected in well 350 of foam receptacle 300.

Retaining member 500, along with reservoir 200 and funnel 250, can then be removed to access foam receptacle 300 and protective wrap 400. Protective wrap 400 can then be wrapped around foam receptacle 300, which can be submitted for histologic processing to remove aqueous components from the specimen (e.g. via alcohol or other processing fluids). Other embodiments may obviate the need for a retaining clip as the assembly may comprise a single unit.

Foam receptacle 300 can then be inverted and embedded in paraffin wax to produce the desired cell block. The cell block can be sectioned for further analysis, including for example, immunohistochemical (IHC) staining to classify tumors, cytogenetic analysis, molecular analysis, cytochemical staining analysis, immunofluorescence staining, in situ hybridization analysis, or other methods of histologic or cytologic diagnostic investigation. In certain embodiments, the cell block can be sectioned at 4 microns, while in other embodiments the cell block may be sectioned at different thicknesses.

In particular embodiments, foam receptacle 300 can be formed from an open cell absorbent polymer foam. In certain embodiments foam receptacle 300 may be formed from a two-layer material that includes two absorbent layers 310 and 320 (as shown in FIG. 1). In particular embodiments, well 350 may be formed by forming a cavity in absorbent layer 310 without penetrating the second layer 320. Such a configuration can allow a cell pellet 240 to be formed in well 350 by the centrifuging process. The first absorbent layer of the foam material and the second absorbent layer can therefore retain the cell pellet 240 when apparatus 100 is removed from the centrifuge and foam receptacle 300 and protective wrap 400 are separated from the remaining components of apparatus 100. As used herein, the term “absorbent” is understood to describe a material that absorbs formalin, water, or other liquids used in the preparation of cytologic specimens. It is also understood that in certain embodiments absorbent materials used herein may not absorb cells and other particulate matter.

In particular embodiments, reservoir 200 may be a component in a Cytospin™funnel. Protective wrap 400 may be a tissue paper (including for example, Bio-Wrap™tissue paper) in some embodiments. In certain embodiments well 350 can be formed for example, by 5 mm biopsy punch. In specific embodiments, foam receptacle 300 may have a maximum dimension of less than 5 cm, or less than 4 cm, of less than 3 cm or less than 2 cm. In specific embodiments, foam receptacle 300 may comprise foam with one or more different colors. The colored sections of the foam may be used as reference markers, including for example, to determine a particular depth when foam receptacle 300 is sectioned. In certain embodiments, foam receptacle 300 may have a base portion that has been dyed to indicate to the user that foam receptacle 300 should not be sectioned further. In some embodiments, well 350 may also comprise an indicator to provide a radial orientation of well 350. Such an indicator can be used, for example, to provide a radial orientation of well 350 when it is removed and placed in other components (e.g. a well plate). In a particular embodiment, foam receptacle 300 may be a 1 cm by 1 cm square of acrylic polymer, alkylated acrylic polymer, polymeric 2-Ethylhexyl acrylate, polymeric 2-Ethylhexyl acrylate embedded with divinyl benzene, polymeric 2-Ethylhexyl acrylate with divinyl benzene and calcium chloride, Infinicel™foam, or any other organic derived polymeric material that is approximately 3 mm thick. It is understood that the exemplary embodiments of the present invention are not limited to the specific types or manufacturers of components provided herein, and that other embodiments may comprise different types and manufacturers

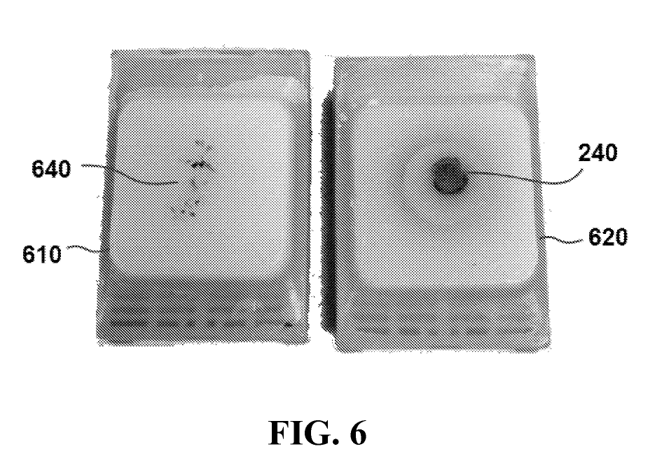

FIG. 6 is a comparison of a cell block prepared according to traditional techniques, and a cell block according to embodiments of the present disclosure. In the image shown, cell block 610 is prepared according to traditional techniques, while cell block 620 is prepared according to the present disclosure. As shown in the figure, the cell block 610 comprises a specimen 640 that is scattered and dispersed throughout cell block 610. In contrast, cell block 620 comprises a cell pellet 240 that is contained in a circular region near the center of cell block 620. Such a configuration can provide for improved analytical techniques, including for example, sectioning and immunohistochemical (IHC) staining.

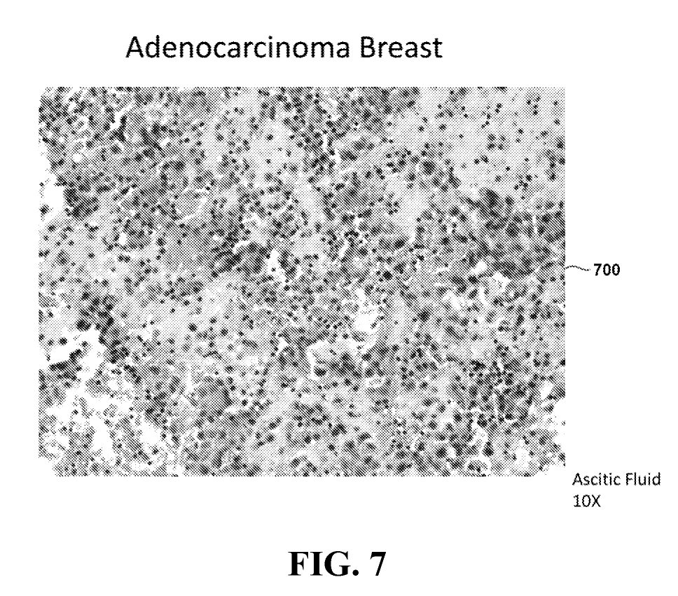

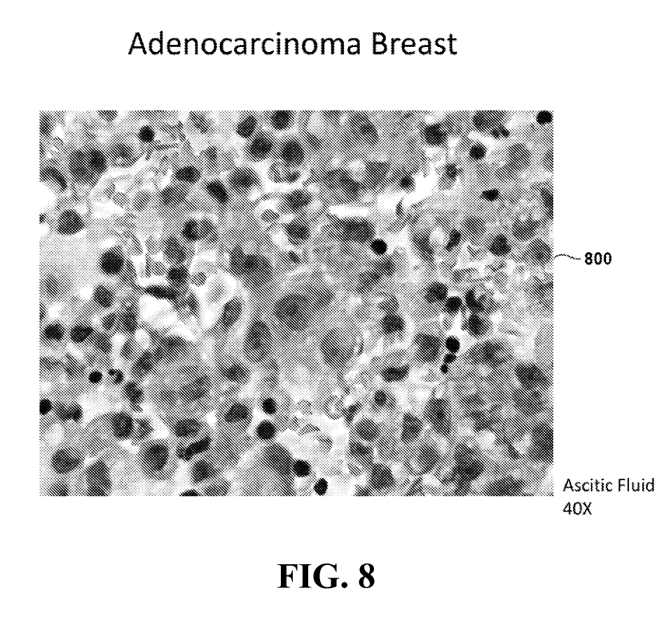

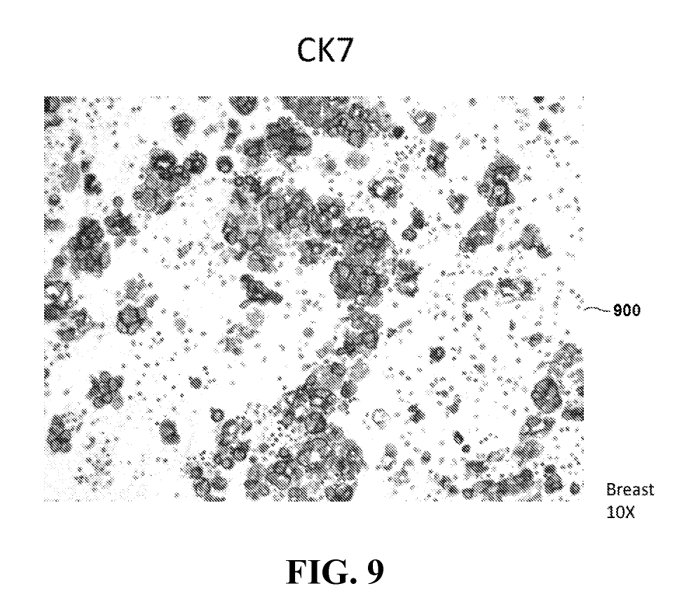

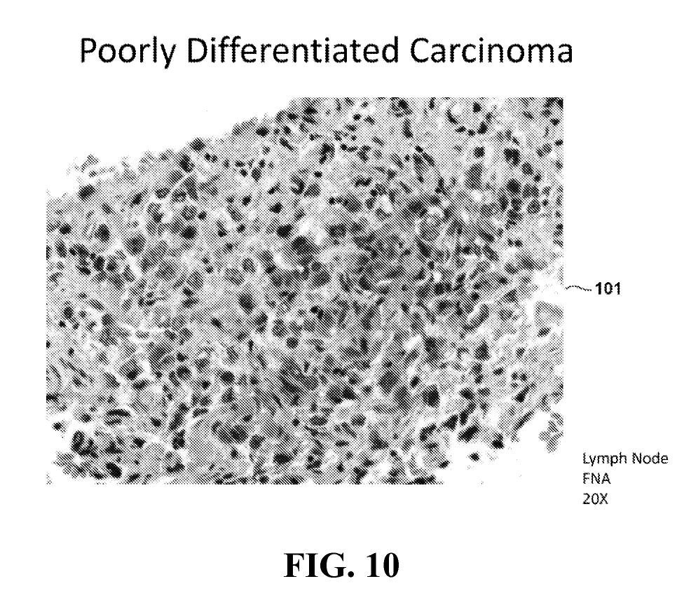

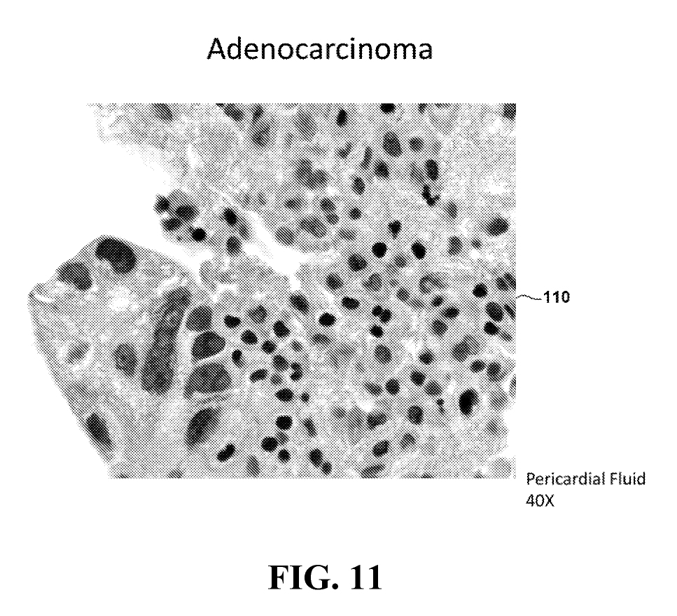

FIGS. 7-11 illustrate images of specimens prepared according to exemplary embodiments of the present disclosure. For example, FIG. 7 is an image 700 of an ascitic fluid specimen prepared according to exemplary embodiments of the present disclosure exhibiting adenocarcinoma at 10× magnification. FIG. 8 is an image 800 of an ascitic fluid specimen prepared according to exemplary embodiments of the present disclosure exhibiting adenocarcinoma at 40× magnification. FIG. 9 is an image of a breast cell specimen prepared according to exemplary embodiments of the present disclosure exhibiting cytokeratin 7 (CK7) at 10× magnification, and FIG. 10 is an image of a lymph node specimen (obtained by fine needle aspiration) prepared according to exemplary embodiments of the present disclosure exhibiting poorly differentiated carcinoma at 20× magnification. FIG. 11 is an image of a pericardial fluid specimen prepared according to exemplary embodiments of the present disclosure exhibiting adenocarcinoma at 10× magnification.

All of the apparatus and/or methods disclosed and claimed herein can be made and executed without undue experimentation in light of the present disclosure. While the apparatus and methods of this invention have been described in terms of preferred embodiments, it will be apparent to those of skill in the art that variations may be applied to the apparatus and/or methods and in the steps or in the sequence of steps of the methods described herein without departing from the concept, spirit and scope of the invention. More specifically, it will be apparent that certain components may be substituted for the components described herein while the same or similar results would be achieved. All such similar substitutes and modifications apparent to those skilled in the art are deemed to be within the spirit, scope, and concept of the invention as defined by the appended claims.

### REFERENCES

The following references, to the extent that they provide exemplary procedural or other details supplementary to those set forth herein, are specifically incorporated herein by reference.

U.S. Patent Publication 2012/0053547

What is claimed is:

1. An apparatus comprising:
a foam receptacle comprising a well; and
a reservoir comprising an aperture proximal to the foam receptacle, wherein:
the reservoir is coupled to the foam receptacle such that the aperture is in fluid communication with the well of the foam receptacle.

2. The apparatus of claim 1 wherein the foam receptacle is an open cell absorbent polymer foam.

3. The apparatus of claim 1 wherein the foam receptacle comprises a first layer and a second layer.

4. The apparatus of claim 1 wherein the first layer and the second layer are comprised of absorbent material.

5. The apparatus of claim 3 wherein the well is formed in the first layer and wherein the well does not extend through the second layer.

6. The apparatus of claim 1, wherein the reservoir further comprises an aspirated specimen comprising suspended biological cells.

7. The apparatus of claim 1, wherein the well in the foam receptacle contains a cell pellet.

8. The apparatus of claim 1 wherein the foam receptacle is approximately 5 mm thick and has a maximum dimension of approximately 3 cm.

9. The apparatus of claim 1 wherein the foam receptacle is a square approximately 1 cm by 1 cm and is approximately 3 mm thick.

10. The apparatus of claim 1 further comprising a funnel in fluid communication with the reservoir.

11. The apparatus of claim 10 further comprising a support member coupling the funnel and the reservoir.

12. The apparatus of claim 1 further comprising a retaining member configured to retain the reservoir and the foam receptacle during a centrifuging process.

13. The apparatus of claim 12 further comprising a support member coupling the funnel and the reservoir.

14. The apparatus of claim 13 wherein the retaining member comprises a clip configured to retain the support member to the retaining member.

15. The apparatus of claim 12 further comprising a protective wrap between the foam receptacle and the retaining member.

16. The apparatus of claim 15 wherein the protective wrap is tissue paper.

17. A method of preparing an embedded cell block cytology specimen, wherein the method comprises:
placing a specimen comprising suspended cells in a reservoir;
centrifuging the specimen from a reservoir to a well in a foam receptacle;
processing the foam receptacle to remove aqueous components from the specimen; and
embedding wax in the foam receptacle.

18. The method of claim 17 further comprising sectioning the foam receptacle into sections.

19. The method of claim 18 wherein the sections are approximately 4 microns thick.

20. The method of claim 17 wherein the reservoir comprises an aperture in fluid communication with the well in the foam receptacle.

21. The method of claim 17 wherein placing the specimen in the reservoir comprises pouring the specimen into a funnel coupled to the reservoir.

22. A cell block comprising:
a first layer comprising an open cell absorbent polymer foam;
a second layer comprising an absorbent material; and
a well formed in the open cell absorbent polymer foam, wherein:
the well does not extend through the second layer;
the cell block is less than 5 mm thick; and
the maximum dimension of the cell block is less than 5 cm.

23. The cell block of claim 22 wherein the maximum dimension of the cell block is less than 4 cm.

24. The cell block of claim 22 wherein the maximum dimension of cell block is less than 3 cm.

25. The cell block of claim 22 wherein the maximum dimension of the cell block is less than 2 cm.

26. The cell block of claim 22 wherein the maximum dimension of the cell block is approximately 1 cm.

27. The cell block of claim 22 further comprising a cell pellet in the well formed in the open cell absorbent polymer foam.

28. The cell block of claim 27, wherein the cell block further comprises paraffin wax embedded in the open cell absorbent polymer foam.
